(19) United States
(12) Patent Application Publication
(10) Pub. No.: US 2019/0275785 A1
(43) Pub. Date: Sep. 12, 2019

(54) METHOD OF PRODUCING PRINTED SUBSTRATE

(71) Applicant: SHARP KABUSHIKI KAISHA, Sakai City (JP)

(72) Inventor: KOHSHIROH TANIIKE, Sakai City (JP)

(21) Appl. No.: 16/295,300

(22) Filed: Mar. 7, 2019

(30) Foreign Application Priority Data
Mar. 9, 2018 (JP) 2018-042863

(51) Int. Cl. B41F 19/00; B41F 5/24

(52) U.S. Cl. CPC B41F 19/001; B41F 5/24

(57) ABSTRACT

A method of producing a printed substrate includes rotating an anilox roll having first recesses supplied with a coating liquid, rotating a plate cylinder fitted with a printing plate having second recesses, transferring the coating liquid from the first recesses to the second recesses and holding the coating liquid in the second recesses, and rotating the plate cylinder while keeping the outer surface of the printing plate in contact with a printed substrate to transfer the coating liquid held in the second recesses to the printed substrate. A ratio of a maximum volume of the coating liquid held by the second recesses per unit area on the outer surface of the printing plate to a maximum volume of the coating liquid held by the first recesses per unit area on the outer surface of the anilox roll ranges from 0.50 to 2.00.

### CROSS REFERENCE TO RELATED APPLICATION

This application claims priority from Japanese Patent Application No. 2018-042863 filed on Mar. 9, 2018. The entire contents of the priority application are incorporated herein by reference.

### TECHNICAL FIELD

The technology described herein relates to a method of producing a printed substrate.

### BACKGROUND

A conventional method of producing a printed substrate is known and according to one example of such a printing method, a meshed synthetic resin sheet is subjected to printing continuously while being transferred in a longitudinal direction thereof. Specifically, this is a method of carrying out printing on a meshed synthetic resin sheet. According to the method, a long sized coarse fabric synthetic resin sheet is formed by uniting with combining warp and weft of one by drawing a synthetic resin film and tearing the same with very narrow width and printing is performed on the obtained mesh-like synthetic resin sheet continuously while being transported. The printing is performed by a flexographic printing and cell volume of an anilox roll supplying a printing ink to a plate cylinder is set so that the printing ink does not leak through a mesh of the mesh-like synthetic resin sheet that is between the plate cylinder and an impression cylinder and does not adhere to the impression cylinder. An example of such a printing method is disclosed in Japanese Unexamined Patent Application Publication No. 2017-61041.

According to the above printing method described in Japanese Unexamined Patent Application Publication No. 2017-61041, the cell volume of the anilox roll, which supplies print ink to the plate cylinder, is determined properly to suppress excessive supply of print ink. However, merely adjusting the cell volume of the anilox roll may result in a shortage or excess of the volume of print ink held by the plate cylinder. An excessive volume of print ink held raises a problem that the thickness of a print ink film formed on the synthetic resin sheet becomes large locally. An insufficient volume of print ink held, on the other hand, raises a problem that a print ink pattern formed on the synthetic resin sheet is faint.

### SUMMARY

The technology described herein was made in view of the above circumstances. An object is to achieve transfer of a coating liquid that ensures superior uniformity of film thickness.

A method of producing a printed substrate according to the technology described herein includes rotating an anilox roll having first recesses on an outer surface of the anilox roll, the outer surface being supplied with a coating liquid, rotating a plate cylinder fitted with a printing plate having second recesses on an outer surface of the printing plate, the outer surface being in contact with the outer surface of the anilox roll, transferring the coating liquid from the first recesses to the second recesses to hold the coating liquid in the second recesses, and rotating the plate cylinder while keeping the outer surface of the printing plate in contact with a substrate surface of a printed substrate to transfer the coating liquid held in the second recesses to the substrate surface of the printed substrate. A ratio of a maximum volume of the coating liquid held by the second recesses per unit area on the outer surface of the printing plate to a maximum volume of the coating liquid held by the first recesses per unit area on the outer surface of the anilox roll is determined to be a ratio ranging from 0.50 to 2.00 (0.50 or larger and 2.00 or smaller).

According to this method, the coating liquid supplied to the outer surface of the anilox roll and held in the first recesses is transferred from the first recesses to the second recesses and is held in the second recesses as the anilox roll and the plate cylinder, the anilox roll having its outer surface kept in contact with the outer surface of the printing plate, are rotated. Afterward, as the plate cylinder with the printing plate having its outer surface kept in contact with the substrate surface of the printed substrate is rotated, the coating liquid in the second recesses is transferred to the substrate surface of the printed substrate. For the first recesses formed on the outer surface of the anilox roll as well as the second recesses formed on the outer surface of the printing plate, the maximum volume of the coating liquid that the recesses can hold is defined as “maximum volume of the coating liquid held in the recesses per unit area on the outer surface”. If the maximum volume of the coating liquid held by the first recesses per unit area on the outer surface of the anilox roll is compared with the maximum volume of the coating liquid held by the second recesses per unit area on the outer surface of the printing plate to find that the former maximum volume is excessively large or the latter maximum volume is excessively small, the second recesses of the printing plate fail to completely hold the coating liquid. This may lead to “film thickness irregularity”, which refers to a phenomenon that the thickness of a film of the coating liquid transferred to the printed substrate becomes large locally. If the maximum volume of the coating liquid held by the first recesses per unit area on the outer surface of the anilox roll is compared with the maximum volume of the coating liquid held by the second recesses per unit area on the outer surface of the printing plate to find that the former maximum volume is excessively small or the latter maximum volume is excessively large, on the other hand, the coating liquid held in the second recesses of the printing plate becomes insufficient in volume. This may lead to “faint”, which refers to formation of mottled patterns made up of spots where the coating liquid is transferred to the printed substrate and spots where the coating liquid is not transferred to the printed substrate.

However, by determining the ratio of the maximum volume of the coating liquid held by the second recesses per unit area on the outer surface of the printing plate to the maximum volume of the coating liquid held by the first recesses per unit area on the outer surface of the anilox roll to be a ratio ranging from 0.50 to 2.00 (0.50 or larger and 2.00 or smaller), a proper volume of the coating liquid transferred to the printed substrate is ensured. Specifically, determining the above ratio to be equal to or larger than 0.50 hardly allows the coating liquid transferred from the first recesses of the anilox roll to the second recesses of the printing plate to become excessive in volume, and therefore allows the second recesses of the printing plate to hold the coating liquid properly. This is preferable for achieving the uniform thickness of a film of the coating liquid transferred to the printed substrate. Determining the above ratio to be equal to or smaller than 2.00, on the other hand, hardly allows the coating liquid transferred from the first recesses of the anilox roll to the second recesses of the printing plate to become insufficient in volume, and therefore allows the second recesses of the printing plate to hold a sufficient volume of the coating liquid. This prevents formation of a spot where the coating liquid is not transferred to the printed substrate. As a result, it becomes easier to transfer the coating liquid to the printed substrate, as a film with a uniform thickness. Note that, even if the ratio is determined to be within the above value ranges, for example, adjusting the printing pressure of the printing plate to the printed substrate may be preferable in some cases.

According to the technology described herein, transfer of a coating liquid that ensures superior uniformity of a film thickness can be achieved.

### BRIEF DESCRIPTION OF THE DRAWINGS

FIG. 1 is a side view of a flexographic printing apparatus according to a first embodiment.

FIG. 2 is a side view of a dispenser, an anilox roll, and a doctor roll that make up the flexographic printing apparatus.

FIG. 3 is a side view of the anilox roll, a plate cylinder, and a flexographic plate that make up the flexographic printing apparatus.

FIG. 4 is a side view showing a process of transferring a coating liquid from the flexographic plate making up the flexographic printing apparatus to a liquid crystal panel substrate.

FIG. 5 is a side view showing a process of transferring the coating liquid from the flexographic plate to the liquid crystal panel substrate, the process being carried out in a first comparative example.

FIG. 6 is a side view showing a process of transferring the coating liquid from the flexographic plate to the liquid crystal panel substrate, the process being carried out in a second comparative example.

FIG. 7 depicts a table indicating the results of a first comparative test.

FIG. 8 is a side view of a dispenser, an anilox roll, a doctor blade, a plate cylinder, a flexographic plate, and a stage that make up a flexographic printing apparatus according to a second embodiment.

FIG. 9 is a side view showing a process of transferring the coating liquid from the flexographic plate making up the flexographic printing apparatus to the liquid crystal panel substrate.

FIG. 10 is a side view of the dispenser, the anilox roll, and the doctor blade that make up the flexographic printing apparatus.

FIG. 11 depicts a table indicating the results of a second comparative test.

FIG. 12 is a side view of the dispenser, the anilox roll, the doctor blade, the plate cylinder, the flexographic plate, and the stage that make up the flexographic printing apparatus according to the second embodiment.

### DETAILED DESCRIPTION

### First Embodiment

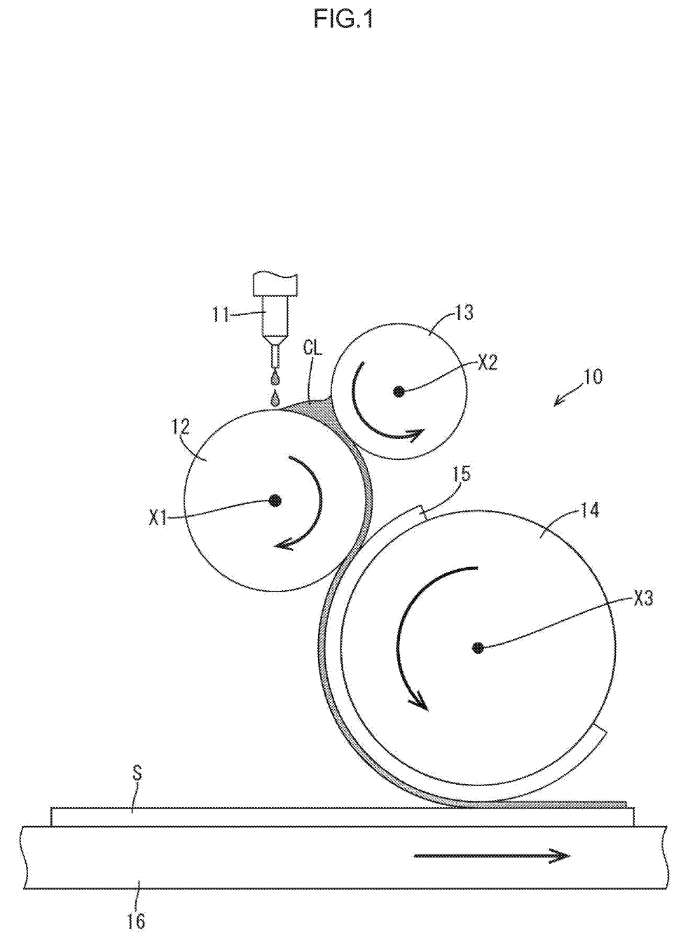

A first embodiment will be described with reference to FIGS. 1 to 7. In the first embodiment, a method of producing a liquid crystal panel substrate S, which is an example of a printed substrate produced by using a flexographic printing apparatus 10 as an example of a production apparatus (printing apparatus), will be described exemplarily.

The flexographic printing apparatus 10 is used to, for example, print (coat) an oriented film forming resin containing a polyimide resin or the like when an oriented film is formed on the liquid crystal panel substrate S making up a liquid crystal panel (display panel). In the first embodiment, the liquid crystal panel substrate S on which the oriented film is formed by the flexographic printing apparatus 10 is a so-called mother substrate carrying array substrates and counter substrates arranged on its substrate surface, the substrates making up the liquid crystal panel.

As shown in FIG. 1, the flexographic printing apparatus 10 includes a dispenser 11 serving as an example of a supply means, an anilox roll 12, a doctor roll 13, and a plate cylinder 14 serving as an example of a transfer means. The plate cylinder 14 is fitted with a flexographic plate 15 serving as an example of a printing plate. The flexographic printing apparatus 10 further includes a stage 16 that sucks and holds the liquid crystal panel substrate S.

As shown in FIG. 1, the dispenser 11 is disposed above the anilox roll 12 such that the dispenser 11 is counter to the anilox roll 12 in the vertical direction. The dispenser 11 delivers a coating liquid CL toward the peripheral wall surface of the anilox roll 12, i.e., the outer surface of the anilox roll 12, thereby supplies the anilox roll 12 with the coating liquid CL. To cause the dispenser 11 to deliver the coating liquid CL at a given pressure, a pressure device may be connected to the dispenser 11. The dispenser 11 may be mounted in such a way as to allow it to reciprocate along a rotating shaft X1 of the anilox roll 12 (reciprocate between the far side and this side of the paper surface in FIG. 1). In this configuration, the dispenser 11 drops the coating liquid CL onto the peripheral wall surface while moving above the peripheral wall of the anilox roll 12.

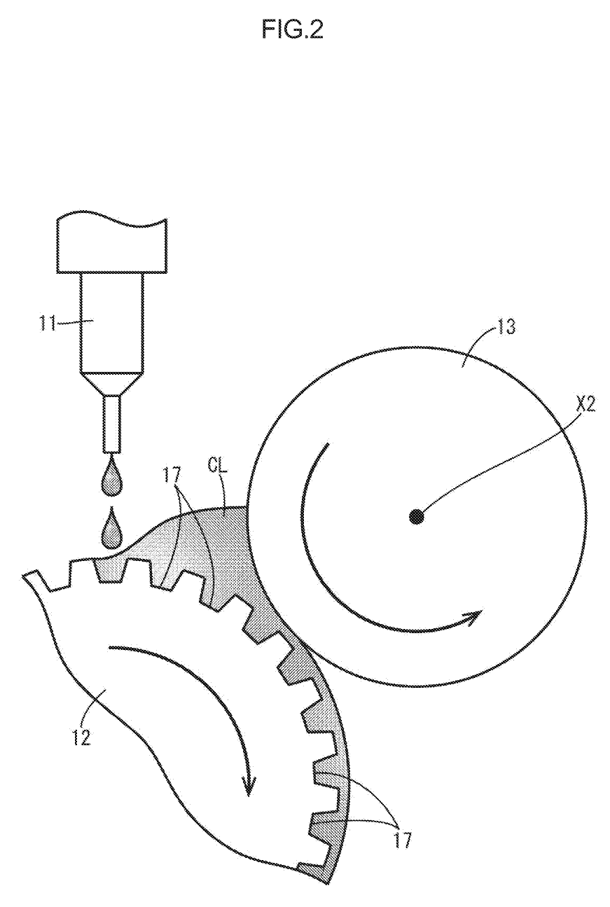

As shown in FIG. 1, the anilox roll 12 is of a substantially columnar shape, and is mounted in such a way as to allow the anilox roll 12 to rotate around the rotating shaft X1 disposed at the center of the anilox roll 12. According to the first embodiment, when the flexographic printing apparatus 10 is seen in a direction indicated in FIG. 1, the anilox roll 12 is pivotally supported to cause it to rotate clockwise. The anilox roll 12 is structured such that most of its peripheral wall surface other than both end areas in a direction along the rotating shaft X1 is covered entirely with circumferentially extending ceramic material plating. As shown in FIG. 2, the ceramic material plating has numbers of fine first recesses 17 arranged dispersively on the entire surface of the ceramic material plating. In FIG. 1, the coating liquid CL is depicted schematically. The first recesses 17 may be referred to as “cells”. Each of numbers of the first recesses 17 can hold a given volume of the coating liquid CL supplied by the dispenser 11. The first recesses 17 as a whole are honeycomb-shaped, being arranged regularly into, for example, a close-packed structure on the surface of the plating. In other words, the plating has a honeycomb-meshed structure. The maximum volume MV1 of the coating liquid CL held by the first recesses 17 on the anilox roll 12 is calculated by multiplying the maximum volume of the coating liquid CL each first recess 17 can hold by the number of first recesses 17 formed, and the maximum volume MV1 is expressed in units of, for example, “cm³”. The maximum volume MVA1 of the coating liquid CL held by the first recesses 17 per unit area on the peripheral wall surface of the anilox roll 12 is then calculated by dividing the above maximum volume MV1 of the coating liquid CL held by the first recesses 17 by the total area of the peripheral wall surface, and the maximum volume MVA1 is expressed in units of, for example, “cm³/m²”.

As shown in FIG. 1, the doctor roll 13 is of a substantially columnar shape, and is mounted in such a way as to allow the doctor roll 13 to rotate around a rotating shaft X2 disposed at the center of the doctor roll 13. The doctor roll 13 is mounted such that its rotating shaft X2 is parallel with the rotating shaft X1 of the anilox roll 12, and rotates in the direction reverse to the direction in which the anilox roll 12 rotates. In other words, according to the first embodiment, the doctor roll 13 is pivotally supported to cause it to rotate counterclockwise in FIG. 1. The doctor roll 13 is disposed such that a part of its peripheral wall surface is in contact with or close to a part of the peripheral wall surface of the anilox roll 12. More specifically, a contact position at which the peripheral wall surface of the doctor roll 13 is in contact with the peripheral wall surface of the anilox roll 12 is located on the rear side in the direction of rotation of the anilox roll 12, relative to a contact position at which the peripheral wall surface of the anilox roll 12 is in contact with the flexographic plate 15 (which will be descried later), that is, located closer to the dispenser 11 than the position at which the peripheral wall surface of the anilox roll 12 is in contact with the flexographic plate 15. As a result, as shown in FIG. 2, the coating liquid CL supplied from the dispenser 11 to the peripheral wall surface of the anilox roll 12 is filled into the first recesses 17 as the anilox roll 12 rotates. At this time, an excess portion of the coating liquid CL present outside the first recesses 17 is drawn by the doctor roll 13. Thus, on the peripheral wall surface of the anilox roll 12, the coating liquid CL is filled into the first recesses 17 only in which the coating liquid CL is uniform in thickness and is the maximum in volume. Meanwhile, the doctor roll 13 is configured such that its positional relation with the anilox roll 12 can be adjusted, that is, its state of contact with (contact pressure to) the peripheral wall surface of the anilox roll 12 can be adjusted. Specifically, locating the peripheral wall surface of the doctor roll 13 relatively close to the peripheral wall surface of the anilox roll 12 creates a state in which little coating liquid CL is present outside the first recesses 17 on the peripheral wall surface of the anilox roll 12 or a state in which a little volume of the coating liquid CL is present outside the first recesses 17. In contrast, locating the peripheral wall surface of the doctor roll 13 relatively distant to the peripheral wall surface of the anilox roll 12 creates a state in which a large volume of the coating liquid CL is present outside the first recesses 17 on the peripheral wall surface of the anilox roll 12. In this manner, adjusting the positional relation of the doctor roll 13 with the anilox roll 12 allows controlling the volume of the coating liquid CL that could be present outside the first recesses 17 on the peripheral wall surface of the anilox roll 12.

As shown in FIG. 1, the plate cylinder 14 is of a substantially columnar shape having a diameter larger than that of the anilox roll 12, and is mounted in such a way as to allow the plate cylinder 14 to rotate around a rotating shaft X3 disposed at the center of the plate cylinder 14. The plate cylinder 14 is mounted such that its rotating shaft X3 is parallel with the rotating shaft X1 of the anilox roll 12. The plate cylinder 14 is structured such that the flexographic plate 15 is fixed firmly to a part of the peripheral wall surface of the plate cylinder 14 in its circumferential direction. The plate cylinder 14 rotates in the direction reverse to the direction in which the anilox roll 12 rotates. In other words, according to the first embodiment, the plate cylinder 14 is pivotally supported to cause it to rotate counterclockwise in FIG. 1. The contact position at which the outer surface of the flexographic plate 15 is in contact with the peripheral wall surface of the anilox roll 12 is located on the front side in the direction of rotation of the anilox roll 12, relative to the contact position at which the peripheral wall surface of the anilox roll 12 is in contact with the doctor roll 13. When the anilox roll 12 and the plate cylinder 14 rotate in their respective directions reverse to each other, the outer surface of the flexographic plate 15 is rotated and pressed to the peripheral wall surface of the anilox roll 12. As a result, the coating liquid CL held in the first recesses 17 formed on the peripheral wall surface of the anilox roll 12 is transferred to the outer surface of the flexographic plate 15. The plate cylinder 14 is disposed such that the outer surface of the flexographic plate 15 is in contact with the liquid crystal panel substrate S (which will be described later) at a position that is on the front side in the direction of rotation of the plate cylinder 14, relative to the contact position at which the outer surface of the flexographic plate 15 is in contact with the peripheral wall surface of the anilox roll 12.

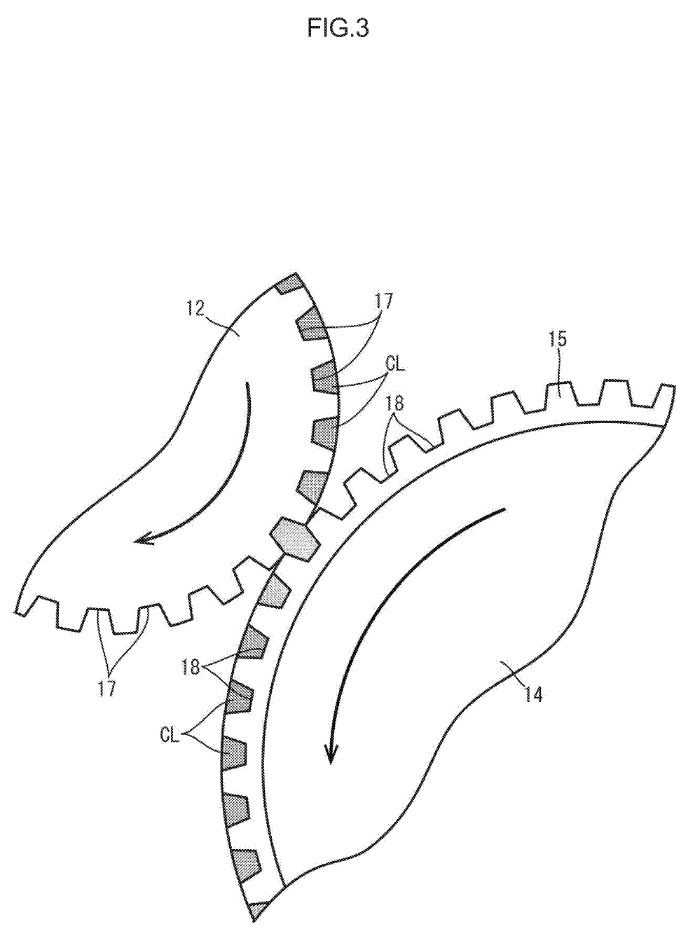

The flexographic plate 15 is made of a resin, such as polybutadiene. As shown in FIG. 3, numbers of fine second recesses 18 corresponding a print pattern of the coating liquid CL are formed on the surface of the flexographic plate 15. Each of numbers of the second recesses 18 can hold a given volume of the coating liquid CL transferred from the anilox roll 12. The maximum volume MV2 of the coating liquid CL held by the second recesses 18 on the flexographic plate 15 is calculated by multiplying the maximum volume of the coating liquid CL each second recess 18 can hold by the number of second recesses 18 formed, and the maximum volume MV2 is expressed in units of, for example, “cm³”. The maximum volume MVA2 of the coating liquid CL held by the second recesses 18 per unit area on the outer surface of the flexographic plate 15 is then calculated by dividing the above maximum volume MV2 of the coating liquid CL held by the second recesses 18 by the total area of the outer surface, and the maximum volume MVA2 is expressed in units of, for example, “cm³/m²”.

As shown in FIG. 1, the liquid crystal panel substrate S, which is a work to be printed, is placed on the stage 16. The stage 16 has numbers of suction holes on its surface, the suction holes being connected to, for example, vacuum piping, and fixes the liquid crystal panel substrate S placed on the surface by sucking the liquid crystal panel substrate S through the suction holes. The stage 16 in the flexographic printing apparatus 10 is configured to move (displace) relative to the plate cylinder 14 along a direction meeting at right angles with the rotating shaft X3 of the plate cylinder 14 and being parallel with the substrate surface of the liquid crystal panel substrate S, that is, along the left-to-right direction indicated in FIG. 1. The stage 16 moves in such a way as to follow the rotation of the plate cylinder 14 in the forward direction, and therefore can move in synchronization with the rotation of the plate cylinder 14. As a result, the coating liquid CL held on the outer surface of the flexographic plate 15 is transferred to the substrate surface of the liquid crystal panel substrate S. According to the first embodiment, because the flexographic printing apparatus 10 that has the doctor roll 13 and causes the stage 16 to move relative to the plate cylinder 14 is used, the size of the liquid crystal panel substrate S to be produced should preferably be, for example, equal to or smaller than the size of the liquid crystal panel substrate of the 4.5th generation (730 mm×920 mm).

The flexographic printing apparatus 10 according to the first embodiment has the above structure. A method of flexographic printing of an oriented film using the flexographic printing apparatus 10, that is, an example of a method of producing the liquid crystal panel substrate S will then be described.

First, the positional relation of the doctor roll 13 with the anilox roll 12 is adjusted, as shown in FIG. 1. In this state, the dispenser 11 is caused to deliver the coating liquid CL, and the anilox roll 12, the doctor roll 13, and the plate cylinder 14 are caused to rotate in their respective preset directions. As a result, as shown in FIG. 2, the coating liquid CL coming out of a delivery port of the dispenser 11 and dropping onto the peripheral wall surface of the anilox roll 12 is filled into the first recesses 17 and is held therein as the anilox roll 12 rotates. At this time, an excess portion of the coating liquid CL present outside the first recesses 17 is drawn by the doctor roll 13 set in contact with or close to the peripheral wall surface of the anilox roll 12. Thus, the coating liquid CL supplied to the peripheral wall surface of the anilox roll 12 is filled into the first recesses 17 in which the coating liquid CL is uniform in thickness and is the maximum in volume. In some cases, a portion of the coating liquid CL remains outside the first recesses 17 on the peripheral wall surface of the anilox roll 12, that is, remains on a surface that comes in contact with the doctor roll 13 and with the flexographic plate 15. The volume of such a portion of the coating liquid CL may change depending on the positional relation of the doctor roll 13 with the anilox roll 12.

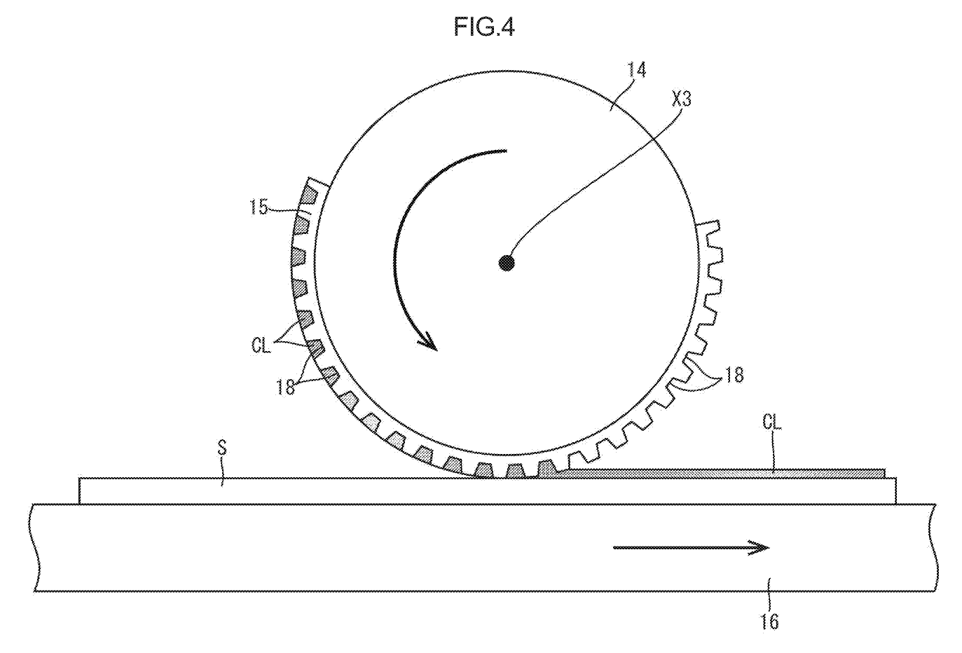

When the anilox roll 12 and the plate cylinder 14 rotate in their respective directions reverse to each other, as shown in FIG. 3, the coating liquid CL held in the first recesses 17 on the peripheral wall surface of the anilox roll 12 is transferred to the second recesses 18 on the outer surface of the flexographic plate 15. When the entire part of the outer surface of the flexographic plate 15 comes in contact sequentially with the peripheral wall surface of the anilox roll 12 in the circumferential direction of the plate cylinder 14, the coating liquid CL is filled into substantially all of the second recesses 18 and is held therein. Subsequently, the plate cylinder 14 with the flexographic plate 15 having the front end of its outer surface in the direction of rotation of the plate cylinder 14 in contact with the front end of the substrate surface of the liquid crystal panel substrate S in the direction of move of the stage 16 (right end of the substrate surface of the liquid crystal panel substrate S shown in FIGS. 1 and 4) is rotated as the stage 16 is moved to follow the rotation of the plate cylinder 14 in the forward direction. As a result, as shown in FIG. 4, the coating liquid CL held in the second recesses 18 is transferred sequentially to the substrate surface of the liquid crystal panel substrate S. The plate cylinder 14 is rotated and the stage 16 is moved until the rear end of the outer surface of the flexographic plate 15 in the direction of rotation of the plate cylinder 14 reaches the position of the rear end of the substrate surface of the liquid crystal panel substrate S in the direction of move of the stage 16. By this process, substantially the whole area of the substrate surface of the liquid crystal panel substrate S is coated with the coating liquid CL to form an oriented film.

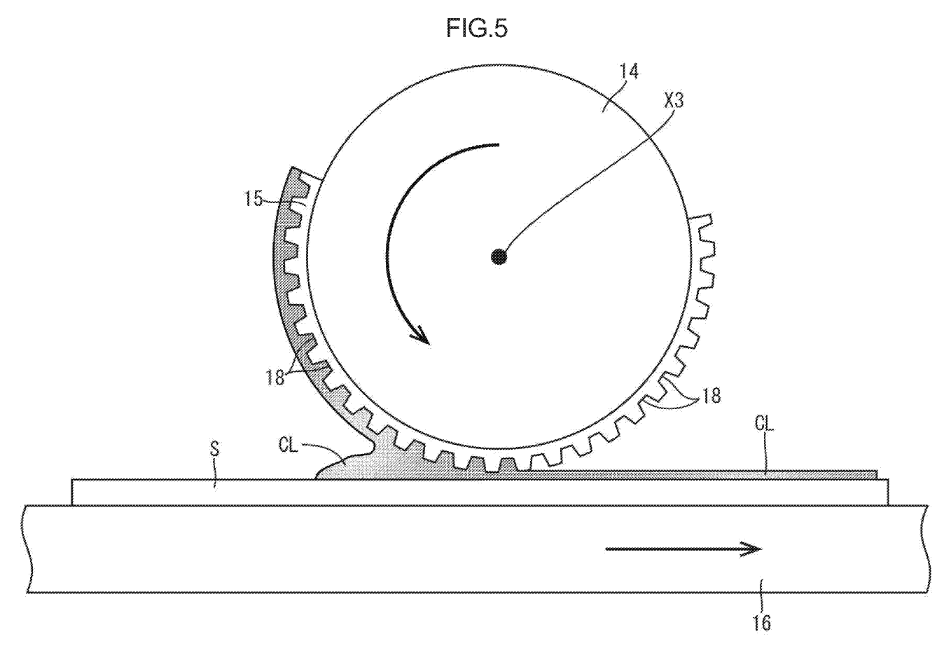

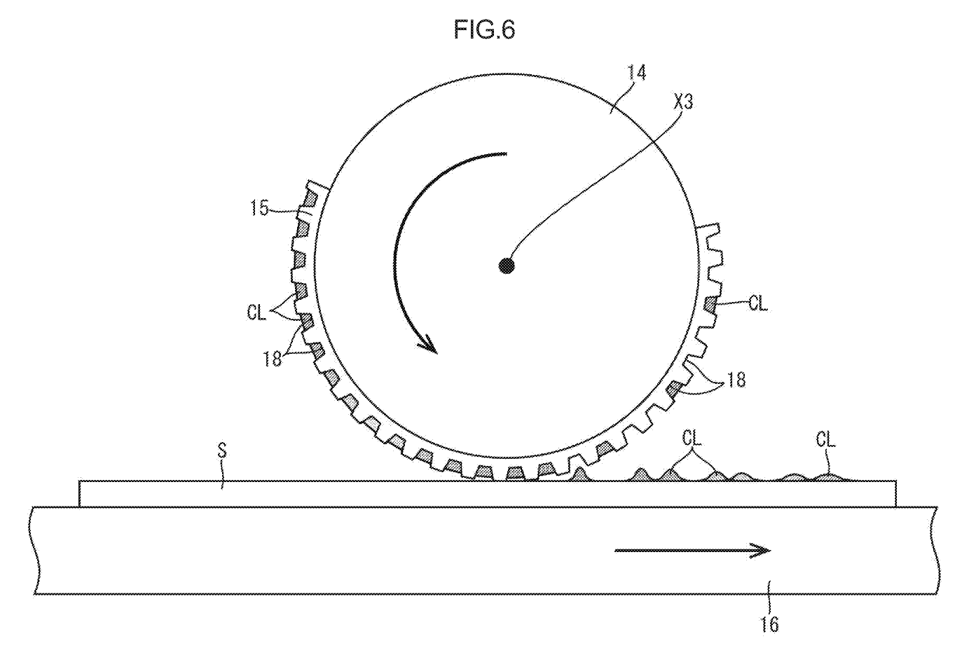

Now, for comparison with the first embodiment, first and second comparative examples will be described with reference to FIGS. 5 and 6. In the description of the first and second comparative examples, for convenience, their constituent elements are denoted by the same reference numerals as used in the first embodiment. The first comparative example is the example in which comparing the maximum volume MVA1 of the coating liquid CL held by the first recesses 17 per unit area on the outer surface of the anilox roll 12 with the maximum volume MVA2 of the coating liquid CL held by the second recesses 18 per unit area on the outer surface of the flexographic plate 15 reveals that the former maximum volume MVA1 is excessively large or the latter maximum volume MVA2 is excessively small. In the first comparative example, as shown in FIG. 5, the second recesses 18 of the flexographic plate 15 fail to completely hold the coating liquid CL, forming a pool of the coating liquid CL between the flexographic plate 15 and the liquid crystal panel substrate S. As a result, near the rear end of the liquid crystal panel substrate S in the direction of move of the plate cylinder 14, a part where the thickness of a film of the coating liquid CL to be transferred becomes locally large is formed, which may develop into a flaw called “film thickness irregularity”. The second comparative example will then be described. The second comparative example is the example in which comparing the maximum volume MVA1 of the coating liquid CL held by the first recesses 17 per unit area on the outer surface of the anilox roll 12 with the maximum volume MVA2 of the coating liquid CL held by the second recesses 18 per unit area on the outer surface of the flexographic plate 15 reveals that the former maximum volume MVA1 is excessively small or the latter maximum volume MVA2 is excessively large. In the second comparative example, as shown in FIG. 6, the coating liquid CL held in the second recesses 18 of the flexographic plate 15 tend to be insufficient in volume. This may lead to “faint”, which refers to formation of mottled patterns made up of spots where the coating liquid CL is transferred to the liquid crystal panel substrate S and spots where the coating liquid CL is not transferred to the liquid crystal panel substrate S.

However, according to the first embodiment, a ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12, that is, “MVA2/MVA1” is determined to be a ratio ranging from 0.50 to 2.00 (0.50 or larger and 2.00 or smaller). This ratio ensures a proper volume of the coating liquid CL transferred to the liquid crystal panel substrate S. Specifically, determining the above ratio “MVA2/MVA1” to be equal to or larger than 0.50 hardly allows the coating liquid CL transferred from the first recesses 17 of the anilox roll 12 to the second recesses 18 of the flexographic plate 15 to become excessive in volume, and therefore allows the second recesses 18 of the flexographic plate 15 to hold the coating liquid CL properly. This is preferable for achieving the uniform thickness of a film of the coating liquid CL transferred to the liquid crystal panel substrate S. Determining the above ratio “MVA2/MVA1” to be equal to or smaller than 2.00, on the other hand, hardly allows the coating liquid CL transferred from the first recesses 17 of the anilox roll 12 to the second recesses 18 of the flexographic plate 15 to become insufficient in volume, and therefore allows the second recesses 18 of the flexographic plate 15 to hold a sufficient volume of the coating liquid CL. This prevents formation of a spot where the coating liquid CL is not transferred to the liquid crystal panel substrate S. As a result, it becomes easier to transfer the coating liquid CL to the liquid crystal panel substrate S, as a film with a uniform thickness.

In particular, according to the first embodiment, an excess portion of the coating liquid CL supplied to the outer surface of the anilox roll 12 is drawn by the doctor roll 13. By adjusting the contact pressure of the doctor roll 13 to the anilox roll 12, therefore, a given amount of the coating liquid CL can be held at the outside of the first recesses 17 on the outer surface of the anilox roll 12. Using the doctor roll 13 offers the following advantage. Even when the ratio “MVA2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12 is larger than 1.70 and equal to or smaller than 2.00, by adjusting the contact pressure of the doctor roll 13 to the anilox roll 12, in addition to the coating liquid CL held in the first recesses 17 on the outer surface of the anilox roll 12, the coating liquid CL held outside the first recesses 17 is transferred to the second recesses 18 of the flexographic plate 15. A case where the coating liquid CL transferred to the second recesses 18 is insufficient in volume, therefore, hardly occurs. As a result, development of “faint” is suppressed.

It is more preferable that the ratio “MVA2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12 be a ratio ranging from 0.90 to 1.70 (0.90 or larger and 1.70 or smaller). When the ratio “MVA2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12 is equal to or larger than 0.50 and smaller than 0.90, or is larger than 1.70 and equal to or smaller than 2.00, not adjusting the printing pressure of the flexographic plate 15 to the liquid crystal panel substrate S may lead to development of “film thickness irregularity” or “faint”. However, when the ratio “MVA2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12 is determined to be the ratio ranging from 0.90 to 1.70 (0.90 or larger and 1.70 or smaller), a proper volume of the coating liquid CL transferred to the liquid crystal panel substrate S is ensured without adjusting the printing pressure of the flexographic plate 15 to the liquid crystal panel substrate S, and therefore development of “film thickness irregularity” or “faint” is suppressed. This offers high productivity.

It is more preferable that the ratio “MVA2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12 be a ratio ranging from 0.90 to 1.40 (0.90 or larger and 1.40 or smaller). When the ratio “MVA2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12 is larger than 1.40 and equal to or smaller than 1.70, not adjusting the contact pressure of the doctor roll 13 to the anilox roll 12 may lead to development of “faint”. However, when the ratio “MVA2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12 is determined to be the ratio ranging from 0.90 to 1.40 (0.90 or larger and 1.40 or smaller), a proper volume of the coating liquid CL transferred to the liquid crystal panel substrate S is ensured without adjusting the contact pressure of the doctor roll 13 to the anilox roll 12, and therefore development of “faint” is suppressed. This offers high productivity.

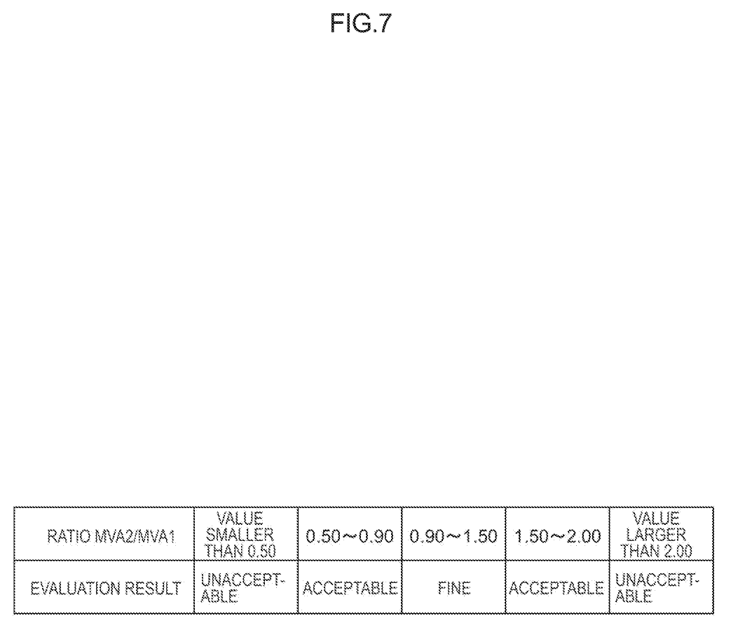

A first comparative test described below has been conducted to obtain knowledge about a way in which the state of the coating liquid CL transferred to the outer surface of the produced liquid crystal panel substrate S changes when the above ratio “MVA2/MVA1” is changed. In the first comparative test, the liquid crystal panel substrate S is produced using the flexographic printing apparatus 10 according to the first embodiment under conditions in which the above ratio “MVA2/MVA1” varies, and the finished state of a coating film CL (oriented film) formed on the outer surface of the produced liquid crystal panel substrate S is evaluated by a worker who visually checks the coating film CL. Whether the coating film CL is uniform in thickness is checked as evaluation criteria. When the coating film CL sufficiently uniform in thickness is formed without making specific adjustment, an evaluation result “fine” is given. When the uniformity of the thickness of the coating film CL is ensured by making prescribed adjustment, an evaluation result “acceptable” is given. When the coating film CL remains non-uniform in thickness after making adjustment, an evaluation result “unacceptable” is given. The results of the first comparative test are indicated in a table shown in FIG. 7. “Adjustment” mentioned here refers to work of adjusting the printing pressure of the flexographic plate 15 to the liquid crystal panel substrate S and of adjusting the contact pressure of the doctor roll 13 to the anilox roll 12.

The results of the first comparative test will be described. FIG. 7 indicates that the evaluation result “unacceptable” is given when the above ratio “MVA2/MVA1” is determined to be smaller than 0.50 or to be larger than 2.00. When the ratio “MVA2/MVA1” is smaller than 0.50, the second recesses 18 of the flexographic plate 15 fail to completely hold the coating liquid CL, forming a pool of the coating liquid CL between the flexographic plate 15 and the liquid crystal panel substrate S. As a result, a part where the thickness of a film of the coating liquid CL becomes locally large is formed on the liquid crystal panel substrate S. When the ratio “MVA2/MVA1” is larger than 2.00, the coating liquid CL held in the second recesses 18 of the flexographic plate 15 tend to be insufficient in volume, leading to “faint” of the coating liquid CL on the liquid crystal panel substrate S. In these cases, even if the printing pressure of the flexographic plate 15 to the liquid crystal panel substrate S or the contact pressure of the doctor roll 13 to the anilox roll 12 is adjusted, the state of the coating liquid CL applied to the liquid crystal panel substrate S is hardly improved.

However, determining the above ratio “MVA2/MVA1” to be the ratio ranging from 0.50 to 2.00 (0.50 or larger and 2.00 or smaller) gives the evaluation result “fine” or “acceptable”. Specifically, determining the above ratio “MVA2/MVA1” to be a ratio ranging from 0.90 to 1.50 (0.90 or larger and 1.50 or smaller) gives the evaluation result “fine”, and determining the ratio “MVA2/MVA1” to be equal to or larger than 0.50 and smaller than 0.90 or to be larger than 1.50 and equal to or smaller than 2.00 gives the evaluation result “acceptable”. When the ratio “MVA2/MVA1” is equal to or larger than 0.50 and smaller than 0.90 or is larger than 1.50 and equal to or smaller than 2.00, the state of the coating liquid CL applied to the liquid crystal panel substrate S is generally fine. Still, slight faint or film thickness irregularity may result. In this case, making adjustment of the printing pressure of the flexographic plate 15 to the liquid crystal panel substrate S or of the contact pressure of the doctor roll 13 to the anilox roll 12 improves the state of the coating liquid CL applied to the liquid crystal panel substrate S. This offers film quality equivalent to “fine”. When the “MVA2/MVA1” is the ratio ranging from 0.90 to 1.50 (0.90 or larger and 1.50 or smaller), the fine state of the coating liquid CL applied to the liquid crystal panel substrate S is achieved without making the above adjustment. This allows an improvement in a non-defective ratio and productivity. According to the first comparative test, the maximum volumes MVA2 and MVA1 that determine the same ratio “MVA2/MVA1” vary in their respective values. When the values of the maximum volumes MVA2 and MVA1 are both large, the thickness of a film of the coating liquid CL transferred to the outer surface of the liquid crystal panel substrate S tends to be large. When the values of the maximum volumes MVA2 and MVA1 are both small, the thickness of a film of the coating liquid CL transferred to the outer surface of the liquid crystal panel substrate S tends to be small. The oriented film formed by applying the coating liquid CL to the outer surface of the liquid crystal panel substrate S does not offer a sufficient anchoring effect, which is an effect of regulating a state of orientation of liquid crystal molecules, if the thickness of the film is sufficiently uniform but is too small. It is preferable, from this point of view, that the thickness of the film of the coating liquid CL applied to the outer surface of the liquid crystal panel substrate S be determined to be a thickness that is at least needed to give the oriented film a thickness for offering the anchoring effect. It is preferable, for this reason, that the contact pressure of the doctor roll 13 to the anilox roll 12 be adjusted properly.

As described above, the method of producing the liquid crystal panel substrate (printed substrate) S according to the first embodiment includes rotating the anilox roll 12 having the first recesses 17 formed on its outer surface supplied with the coating liquid CL and rotating the plate cylinder 14 fitted with the flexographic plate (printing plate) 15 having the second recesses 18 formed on its outer surface in contact with the outer surface of the anilox roll 12, to transfer the coating liquid CL from the first recesses 17 to the second recesses 18 and hold the coating liquid CL in the second recesses 18, and rotating the plate cylinder 14 while keeping the outer surface of the flexographic plate 15 in contact with the substrate surface of the liquid crystal panel substrate (printed substrate) S to transfer the coating liquid CL held in the second recesses 18 to the substrate surface of the liquid crystal panel substrate S. According to the method, the ratio “MVA2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12 is determined to be the ratio ranging from 0.50 to 2.00 (0.50 or larger and 2.00 or smaller).

According to this method, the coating liquid CL supplied to the outer surface of the anilox roll 12 and held in the first recesses 17 is transferred from the first recesses 17 to the second recesses 18 and is held therein as the anilox roll 12 and the plate cylinder 14, the anilox roll 12 having its outer surface kept in contact with the outer surface of the flexographic plate 15, are rotated. Afterward, as the plate cylinder 14 with the flexographic plate 15 having its outer surface kept in contact with the substrate surface of the liquid crystal panel substrate S is rotated, the coating liquid CL in the second recesses 18 is transferred to the substrate surface of the liquid crystal panel substrate S. For the first recesses 17 formed on the outer surface of the anilox roll 12 as well as the second recesses 18 formed on the outer surface of the flexographic plate 15, the maximum volume of the coating liquid CL that the recesses can hold is defined as “maximum volume of the coating liquid held by the recesses per unit area on the outer surface”. If the maximum volume MVA1 of the coating liquid CL held by the first recesses 17 per unit area on the outer surface of the anilox roll 12 is compared with the maximum volume MVA2 of the coating liquid CL held by the second recesses 18 per unit area on the outer surface of the flexographic plate 15 to find that the former maximum volume is excessively large or the latter maximum volume is excessively small, the second recesses 18 of the flexographic plate 15 fail to completely hold the coating liquid CL. This may lead to “film thickness irregularity”, which refers to a phenomenon that the thickness of a film of the coating liquid CL transferred to the liquid crystal panel substrate S becomes large locally. If the maximum volume MVA1 of the coating liquid CL held by the first recesses 17 per unit area on the outer surface of the anilox roll 12 is compared with the maximum volume MVA2 of the coating liquid CL held by the second recesses 18 per unit area on the outer surface of the flexographic plate 15 to find that the former maximum volume is excessively small or the latter maximum volume is excessively large, on the other hand, the coating liquid CL held in the second recesses 18 of the flexographic plate 15 becomes insufficient in volume. This may lead to “faint”, which refers to formation of mottled patterns made up of spots where the coating liquid CL is transferred to the liquid crystal panel substrate S and spots where the coating liquid CL is not transferred to the liquid crystal panel substrate S.

However, the ratio “MAV2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held by the first recesses 17 per unit area on the outer surface of the anilox roll 12 is determined to be the ratio ranging from 0.50 to 2.00 (0.50 or larger and 2.00 or smaller). This ratio ensures a proper volume of the coating liquid CL transferred to the liquid crystal panel substrate S. Specifically, determining the above ratio “MVA2/MVA1” to be equal to or larger than 0.50 hardly allows the coating liquid CL transferred from the first recesses 17 of the anilox roll 12 to the second recesses 18 of the flexographic plate 15 to become excessive in volume, and therefore allows the second recesses 18 of the flexographic plate 15 to hold the coating liquid CL properly. This is preferable for achieving the uniform thickness of a film of the coating liquid CL transferred to the liquid crystal panel substrate S. Determining the above ratio “MVA2/MVA1” to be equal to or smaller than 2.00, on the other hand, hardly allows the coating liquid CL transferred from the first recesses 17 of the anilox roll 12 to the second recesses 18 of the flexographic plate 15 to become insufficient in volume, and therefore allows the second recesses 18 of the flexographic plate 15 to hold a sufficient volume of the coating liquid CL. This prevents formation of a spot where the coating liquid CL is not transferred to the liquid crystal panel substrate S. As a result, it becomes easier to transfer the coating liquid CL to the liquid crystal panel substrate S, as a film with a uniform thickness. Note that, even if the ratio “MVA2/MVA1” is determined to be within the above value ranges, adjusting the printing pressure of the flexographic plate 15 to the liquid crystal panel substrate S may be preferable in some cases, for example.

The doctor roll 13 is disposed such that it rotates while being in contact with the outer surface of the anilox roll 12. The doctor roll 13 thus draws an excess portion of the coating liquid CL supplied to the outer surface of the anilox roll 12. In this configuration, the coating liquid CL supplied to the outer surface of the anilox roll 12 is drawn by the doctor roll 13 that rotates while being in contact with the outer surface of the anilox roll 12. By properly adjusting the contact pressure of the doctor roll 13 to the anilox roll 12, therefore, a given volume of the coating liquid CL can be held outside the first recesses 17 on the outer surface of the anilox roll 12. Using the doctor roll 13 offers the following advantage. Even when the ratio “MVA2/MVA1”, i.e., the ratio of the maximum volume MVA2 of the coating liquid CL held by the second recesses 18 per unit area on the outer surface of the flexographic plate 15 to the maximum volume MVA1 of the coating liquid CL held in the first recesses 17 per unit area on the outer surface of the anilox roll 12 is larger than 1.70 and equal to or smaller than 2.00, by adjusting the contact pressure of the doctor roll 13 to the anilox roll 12, in addition to the coating liquid CL held in the first recesses 17 on the outer surface of the anilox roll 12, the coating liquid CL held outside the first recesses 17 is transferred to the second recesses 18 of the flexographic plate 15. A case where the coating liquid CL transferred to the second recesses 18 is insufficient in volume, therefore, hardly occurs. As a result, development of “faint” is suppressed.

The plate cylinder 14 is rotated as the stage 16 sucking and holding the liquid crystal panel substrate S is moved relative the plate cylinder 14. As a result, the coating liquid CL held in the second recesses 18 of the flexographic plate 15 is transferred to the substrate surface of the liquid crystal panel substrate S. In this configuration, the plate cylinder 14 does not need to be moved. Thus, the coating liquid CL held in the second recesses 18 of the flexographic plate 15 can be transferred to the substrate surface of the liquid crystal panel substrate S as the outer surface of the flexographic plate 15 is kept in contact with the outer surface of the anilox roll 12. In this configuration, compared with a configuration in which the stage 16 is not moved, the size of the flexographic printing apparatus 10 increases. For this reason, this configuration is applied preferably to a case where the liquid crystal panel substrate S is small-sized (e.g., a case where the size of the liquid crystal panel substrate S, which is a mother substrate, is equal to or smaller than the size of the 4.5th generation version).

The resin solution containing the oriented film forming resin that orients liquid crystal molecules or the insulative resin is used as the coating liquid CL, and the liquid crystal panel substrate (display panel substrate) S making up the liquid crystal panel (display panel) is used as the printed substrate coated with the coating liquid CL. In this configuration, the resin solution, i.e., the coating liquid CL is transferred to the substrate surface of the liquid crystal panel substrate S, i.e., printed substrate to form an oriented film on the substrate surface of the liquid crystal panel substrate S. The oriented film formed on the substrate surface of the liquid crystal panel substrate S is improved in film thickness uniformity. This improves the display quality of the liquid crystal panel.

### Second Embodiment

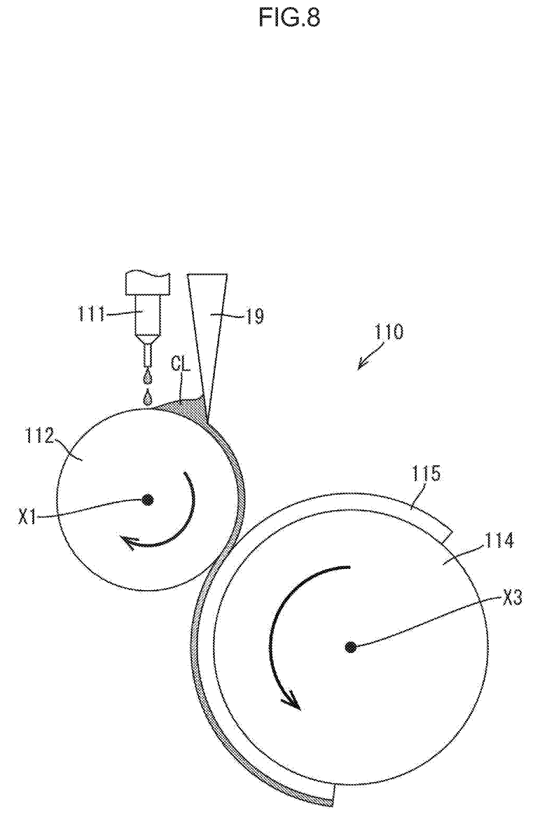

A second embodiment will be described with reference to FIGS. 8 to 11. In the second embodiment, a flexographic printing apparatus 110 has a configuration different from that of the flexographic printing apparatus 10. Description of the same structures and effects as indicated in the above first embodiment will be omitted to avoid redundant descriptions.

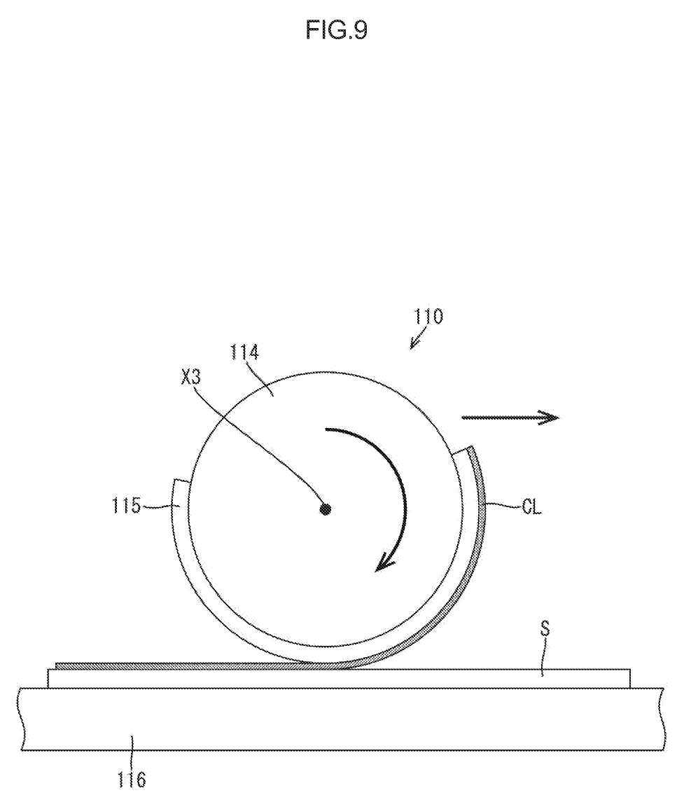

As shown in FIG. 8, the flexographic printing apparatus 110 according to the second embodiment includes a doctor blade 19 provided in place of the doctor roll described in the first embodiment (see FIG. 1). The flexographic printing apparatus 110 further includes a stationary stage 116 shown in FIG. 9, and causes a plate cylinder 114 to move relative to the stage 116 along the substrate surface of the liquid crystal panel substrate S.

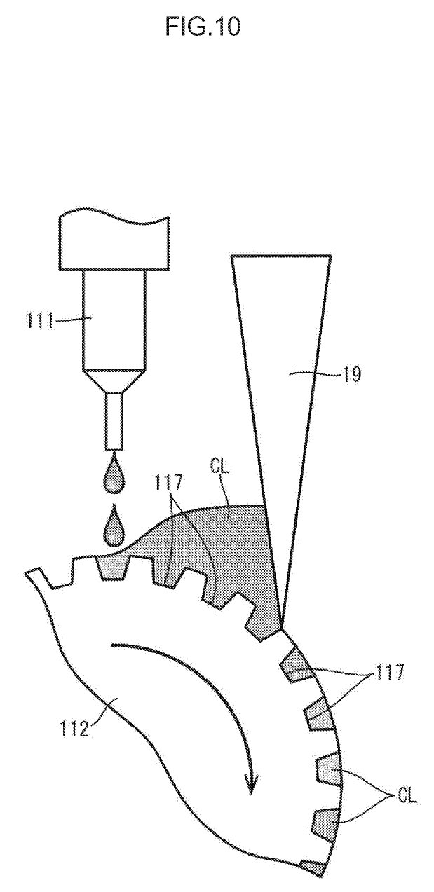

As shown in FIG. 8, the doctor blade 19 has a sectional shape tapering toward its edge. The doctor blade 19 is located on the front side relative to a dispenser 111 in the direction of rotation of an anilox roll 112. The doctor blade 19 is of an elongated shape extending along a rotating shaft X1 of the anilox roll 112 and is made of a resin material, such as polyether ether ketone (PEEK) and polyethylene terephthalate (PET). The doctor blade 19 is disposed such that its edge is in contact with the peripheral wall surface of the anilox roll 112. A contact position at which the doctor blade 19 is in contact with the peripheral wall surface of the anilox roll 112 is the same as the contact position at which the doctor roll is in contact with the peripheral wall surface of the anilox roll in the first embodiment (see FIG. 1). As a result, as shown in FIG. 10, the coating liquid CL supplied from the dispenser 111 to the peripheral wall surface of the anilox roll 112 is filled into first recesses 117 as the anilox roll 112 rotates. At this time, an excess portion of the coating liquid CL present outside the first recesses 117 is scraped by the doctor blade 19. Thus, on the peripheral wall surface of the anilox roll 112, the coating liquid CL is filled into the first recesses 117 only in which the coating liquid CL is uniform in thickness and is the maximum in volume, and little coating liquid CL is present outside the first recesses 117.

As shown in FIGS. 8 and 9, the plate cylinder 114 is configured to move back and forth between a position at which the outer surface of the flexographic plate 115 is in contact with the peripheral wall surface of the anilox roll 112 (state indicated in FIG. 8) and a position at which the outer surface of the flexographic plate 115 is in contact with the substrate surface of the liquid crystal panel substrate S (state indicated in FIG. 9). As shown in FIG. 8, the plate cylinder 114 with the flexographic plate 115 having its outer surface in contact with the peripheral wall surface of the anilox roll 112 rotates in a direction reverse to a direction in which the anilox roll 112 rotates. In other words, according to the second embodiment, the plate cylinder 114 rotates counterclockwise in FIG. 8. In contrast, as shown in FIG. 9, the plate cylinder 114 with the flexographic plate 115 having its outer surface in contact with the substrate surface of the liquid crystal panel substrate S rotates in the same direction in which the anilox roll 112 rotates, that is, rotates clockwise in FIG. 9. In this state, the plate cylinder 114 is allowed to move (displace) relative to the stage 116 along a direction meeting at right angles with a rotating shaft X3 of the plate cylinder 114 and being parallel with the substrate surface of the liquid crystal panel substrate S, that is, along the left-to-right direction indicated in FIG. 9. In this manner, according to the second embodiment, the plate cylinder 114 rotates clockwise and moves rightward relative to the stage 116, as shown in FIG. 9. As a result, the coating liquid CL held on the outer surface of the flexographic plate 115 is transferred to the substrate surface of the liquid crystal panel substrate S. According to the second embodiment, the stage 116 sucking and holding the liquid crystal panel substrate S is fixed such that the stage 116 is not allowed to move at least in the left-to-right direction indicated in FIG. 9. However, it is preferable that the stage 116 be allowed to move up and down in the vertical direction indicated in FIG. 9, in which case the printing pressure of the flexographic plate 115 can be adjusted. According to the second embodiment, because the flexographic printing apparatus 110 that has the doctor blade 19 and causes the plate cylinder 114 to move while keeping the stage 116 stationary is used, the size of the liquid crystal panel substrate S to be produced should preferably be, for example, equal to or larger than the size of the liquid crystal panel substrate of the 5.5th generation (1300 mm×1500 mm). When the size of the liquid crystal panel substrate S to be produced is roughly equal to the size of the liquid crystal panel substrate of the 5th generation (from 1000 mm×1200 mm to 1100 mm×1300 mm), both first embodiment and second embodiment are applicable as a method of producing the liquid crystal panel substrate S.

The flexographic printing apparatus 110 according to the second embodiment has the above structure. A method of flexographic printing of an oriented film using the flexographic printing apparatus 110, that is, an example of a method of producing the liquid crystal panel substrate S will then be described.

First, as shown in FIG. 8, the plate cylinder 114 is set at a position at which the outer surface of the flexographic plate 115 is in contact with the peripheral wall surface of the anilox roll 112. In this state, the dispenser 111 is caused to deliver the coating liquid CL, and the anilox roll 112 and the plate cylinder 114 are caused to rotate in their respective direction reverse to each other. As a result, as shown in FIG. 10, the coating liquid CL coming out of a delivery port of the dispenser 111 and dropping onto the peripheral wall surface of the anilox roll 112 is filled into the first recesses 117 and is held therein as the anilox roll 112 rotates. At this time, an excess portion of the coating liquid CL present outside the first recesses 117 is scraped by the doctor blade 119 that is in slide contact with the peripheral wall surface of the anilox roll 112. Thus, most of the coating liquid CL supplied to the peripheral wall surface of the anilox roll 112 is filled into the first recesses 117 in which the coating liquid CL is uniform in thickness and is the maximum in volume. As a result, little coating liquid CL is present outside the first recesses 117 on the peripheral wall surface of the anilox roll 112, that is, on a surface in contact with the doctor blade 119 and with the flexographic plate 115.

When the anilox roll 112 and the plate cylinder 114 rotate in their respective directions reverse to each other, as shown in FIG. 8, the coating liquid CL held in the first recesses 117 on the peripheral wall surface of the anilox roll 112 is transferred to second recesses on the outer surface of the flexographic plate 115 (see FIGS. 3 and 4 for reference). Afterward, the plate cylinder 114 is moved along the direction meeting at right angles with the rotating shaft X3 and being parallel with the substrate surface of the liquid crystal panel substrate S to separate the outer surface of the flexographic plate 115 away from the peripheral wall surface of the anilox roll 112. The plate cylinder 114 is then moved to a position at which the outer surface of the flexographic plate 115 comes in contact with the substrate surface of the liquid crystal panel substrate S sucked and held by the stage 116, as shown in FIG. 9. At this time, the front end of the outer surface of the flexographic plate 115 in the direction of its rotation (clockwise direction in FIG. 9) is brought into contact with the rear end (left end indicated in FIG. 9) of the substrate surface of the liquid crystal panel substrate S in the direction of move of the plate cylinder 114. In this state, the plate cylinder 114 is moved along the direction parallel with the substrate surface of the liquid crystal panel substrate S while being rotated around the rotating shaft X3. As a result, the outer surface of the flexographic plate 115 is brought into contact with the substrate surface of the liquid crystal panel substrate S such that from the front end up to the rear end of the outer surface in the above direction of rotation come in contact sequentially with the rear end up to the front end of the substrate surface in the above direction of move. Through this process, the coating liquid CL held in the second recesses is transferred to the substrate surface of the liquid crystal panel substrate S. Hence, the coating liquid CL is applied to the substrate surface of the liquid crystal panel substrate S to substantially cover its entire area, thus forming an oriented film.

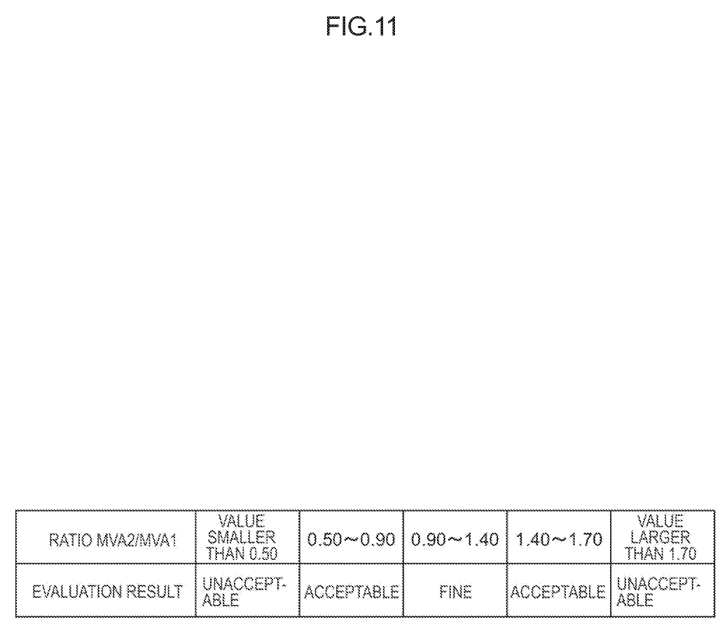

A second comparative test described below has been conducted to obtain knowledge about a way in which the state of the coating liquid CL transferred to the outer surface of the produced liquid crystal panel substrate S changes when the ratio “MVA2/MVA1”, i.e., the ratio of the maximum volume MVA2 of the coating liquid CL held by the second recesses per unit area on the outer surface of the flexographic plate 115 to the maximum volume MVA1 of the coating liquid CL held by the first recesses 117 per unit area on the outer surface of the anilox roll 112 is changed. In the second comparative test, the liquid crystal panel substrate S is produced using the flexographic printing apparatus 110 according to the second embodiment under conditions in which the above ratio “MVA2/MVA1” varies, and the finished state of a coating film CL (oriented film) formed on the outer surface of the produced liquid crystal panel substrate S is evaluated by a worker who visually checks the coating film CL. The same evaluation criteria as used in the first comparative test of the first embodiment are adopted in the second comparative test. The results of the second comparative test are indicated in a table shown in FIG. 11.

The results of the second comparative test will be described mainly through comparison with the results of the first comparative test of the first embodiment. As indicated in FIG. 11, when the above ratio “MVA2/MVA1” is smaller than 0.50 or larger than 1.70, an evaluation result “unacceptable” is given. When the ratio “MVA2/MVA1” is determined to be a ratio ranging from 0.50 to 1.70 (0.50 or larger and 1.70 or smaller), an evaluation result “fine” or “acceptable” is given. Comparing the results of the second comparative test with the results of the first comparative test of the first embodiment reveals that among values for the ratio “MVA2/MVA1” that mark boundaries between “unacceptable” and “acceptable” respectively on the lower limit side and upper limit side, the value on the upper limit side is closer to 1. This means that in the results of the second comparative test, a range of values for the ratio “MVA2/MVA1” that bring the evaluation result “acceptable” is narrower than the same in the results of the first comparative test of the first embodiment. This results because that, according to the second embodiment, the doctor blade 19 used in place of the doctor roll allows little coating liquid CL to remain outside the first recesses 117 on the peripheral wall surface of the anilox roll 112. When the evaluation result “acceptable” is given in the second comparative test, because adjustment of the contact pressure of the doctor roll is not allowed in the second embodiment, adjustment of the printing pressure of the flexographic plate 115 to the liquid crystal panel substrate S is mainly carried out to improve the state of the coating liquid CL applied to the liquid crystal panel substrate S. This offers the liquid crystal panel substrate S whose quality is equivalent to “fine”.

As described above, according to the second embodiment, the doctor blade 19 in contact with the outer surface of the anilox roll 112 scrapes an excess portion of the coating liquid CL supplied to the outer surface of the anilox roll 112, and the ratio “MVA2/MVA1”, i.e., the ratio of the maximum volume MVA2 of the coating liquid CL held by the second recesses per unit area on the outer surface of the flexographic plate 115 to the maximum volume MVA1 of the coating liquid CL held by the first recesses 117 per unit area on the outer surface of the anilox roll 112 is determined to be the ratio ranging from 0.50 to 1.70 (0.50 or larger and 1.70 or smaller). In this configuration, because the doctor blade 19, compared with the doctor roll, hardly deforms when the size of the liquid crystal panel substrate S is increased, using the doctor blade 19 is preferable for producing the liquid crystal panel substrate S of a large size. In addition, because the doctor blade 19 scrapes an excess portion of the coating liquid CL supplied to the outer surface of the anilox roll 112, the coating liquid CL hardly remains outside the first recesses 117 on the outer surface of the anilox roll 112. Under this condition, the ratio “MVA2/MVA1”, i.e., the ratio of the maximum volume MVA2 of the coating liquid CL held by the second recesses per unit area on the outer surface of the flexographic plate 115 to the maximum volume MVA1 of the coating liquid CL held by the first recesses 117 per unit area on the outer surface of the anilox roll 112 is determined to be the ratio ranging from 0.50 to 1.70 (0.50 or larger and 1.70 or smaller). When the doctor blade 19 is used, specifically, in a case where the ratio “MVA2/MVA1” is larger than 1.70 and equal to or smaller than 2.00, the coating liquid CL transferred from the first recesses 117 of the anilox roll 112 to the second recesses of the flexographic plate 115 becomes insufficient in volume, which may lead to development of “faint”. However, determining the ratio “MVA2/MVA1” to be equal to or smaller than 1.70 hardly allows the coating liquid CL transferred from the first recesses 117 of the anilox roll 112 to the second recesses of the flexographic plate 115 to become insufficient in volume, thus suppressing development of “faint”. Note that, even if the ratio “MVA2/MVA1” is the ratio ranging from 0.50 to 1.70 (0.50 or larger and 1.70 or smaller), for example, adjusting the printing pressure of the flexographic plate 115 to the liquid crystal panel substrate S may be preferable in some cases.

It is more preferable that the ratio “MVA2/MVA1”, i.e., the ratio of the maximum volume MVA2 of the coating liquid CL held by the second recesses per unit area on the outer surface of the flexographic plate 115 to the maximum volume MVA1 of the coating liquid CL held by the first recesses 117 per unit area on the outer surface of the anilox roll 112 is determined also to be a ratio ranging from 0.90 to 1.40 (0.90 or larger and 1.40 or smaller). When the ratio “MVA2/MVA1”, i.e., the ratio of the maximum volume MVA2 of the coating liquid CL held by the second recesses per unit area on the outer surface of the flexographic plate 115 to the maximum volume MVA1 of the coating liquid CL held by the first recesses 117 per unit area on the outer surface of the anilox roll 112 is determined to be equal to or larger than 0.50 and smaller than 0.90 or to be larger than 1.40 and equal to or smaller than 1.70, not adjusting the printing pressure of the flexographic plate 115 to the liquid crystal panel substrate S may lead to development of “film thickness irregularity” or “faint”. However, when the ratio “MVA2/MVA1”, i.e., the ratio of the maximum volume MVA2 of the coating liquid CL held by the second recesses per unit area on the outer surface of the flexographic plate 115 to the maximum volume MVA1 of the coating liquid CL held by the first recesses 117 per unit area on the outer surface of the anilox roll 112 is determined to be the ratio ranging from 0.90 to 1.40 (0.90 or larger and 1.40 or smaller), a proper volume of the coating liquid CL transferred to the liquid crystal panel substrate S is ensured without adjusting the printing pressure of the flexographic plate 115 to the liquid crystal panel substrate S, and therefore development of “film thickness irregularity” or “faint” is suppressed. This offers high productivity.

The plate cylinder 114 is rotated while being moved relative to the stage 116 sucking and holding the liquid crystal panel substrate S. As a result, the coating liquid CL held in the second recesses of the flexographic plate 115 is transferred to the substrate surface of the liquid crystal panel substrate S. In this configuration, because the stage 116 does not need to be moved, an increase in the size of the flexographic printing apparatus (production apparatus) 110 is avoided. This configuration is, therefore, preferable for a case where the liquid crystal panel substrate S is large-sized.

### Third Embodiment

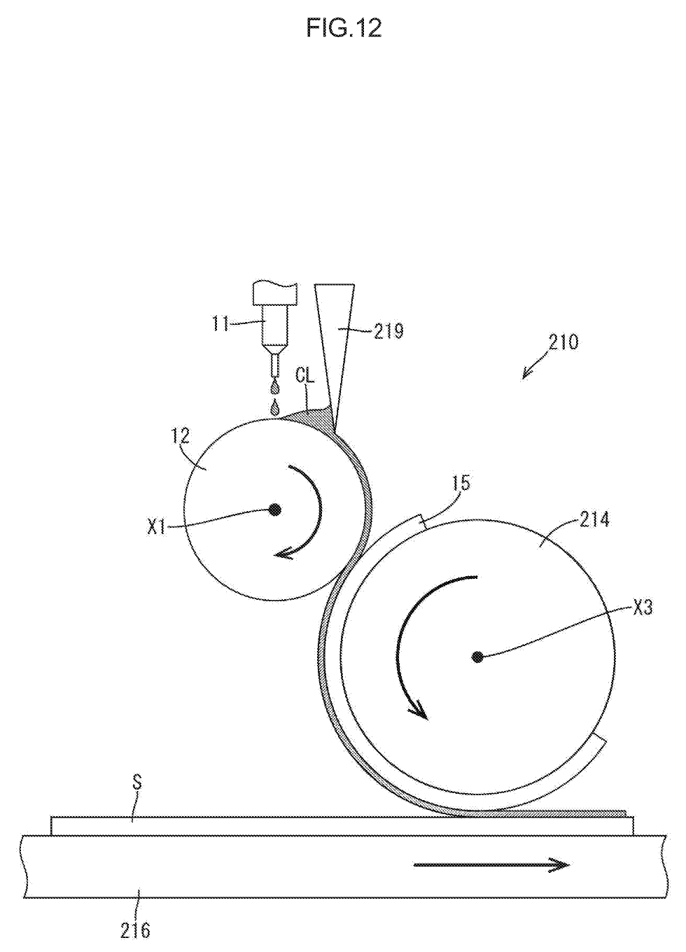

A third embodiment will be described with reference to FIG. 12. In the third embodiment, a flexographic printing apparatus 210 obtained by changing the configuration of the flexographic printing apparatus 10 of the first embodiment will be described. Description of the same structures and effects as indicated in the above first embodiment will be omitted to avoid redundant descriptions.

As shown in FIG. 12, the flexographic printing apparatus 210 according to the third embodiment includes a doctor blade 219 provided in place of the doctor roll described in the first embodiment (see FIG. 1), the doctor blade 219 being similar to the doctor blade 119 described in the second embodiment. The third embodiment is different from the first embodiment in that the doctor blade 219 is used in place of the doctor roll but is similar to the first embodiment in that the stage 216 moves relative to a plate cylinder 214. The configuration of the doctor blade 219 is the same as the configuration of the doctor blade 119 described above in the second embodiment.

### OTHER EMBODIMENTS

The technology described herein is not limited to the embodiments described above and with reference to the drawings. The following embodiments may be included in the technical scope.

(1) The plating of the anilox roll may be made of a chromic material. It is preferable in such a case that the first recesses formed on the surface of the plating made of the chromic material be each made into a pyramidal shape. In other words, it is preferable that the plating made of the chromic material be of a pyramidal meshed structure.

(2) The first recesses may be formed into diamond-shaped patterns, groove-like helical patterns, or the like.

(3) Each of the above embodiments is described as the case where the dispenser that supplies the coating liquid to the anilox roll is provided. However, a tank holding the coating liquid therein and a fountain roll that draws the coating liquid from the tank to supply the coating liquid to the anilox roll may be provided in place of the dispenser.

(4) The coating liquid may not contain the oriented film forming resin and contain the insulative resin.

(5) The technology described herein may be applied to a case where a display panel substrate making up a display panel different from the liquid crystal panel is subjected to printing. The technology described herein may also be applied to a case where a substrate different from the display panel substrate is subjected to printing.

1. A method of producing a printed substrate comprising:
rotating an anilox roll having first recesses on an outer surface of the anilox roll, the outer surface being supplied with a coating liquid;
rotating a plate cylinder fitted with a printing plate having second recesses on an outer surface of the printing plate, the outer surface being in contact with the outer surface of the anilox roll;
transferring the coating liquid from the first recesses to the second recesses to hold the coating liquid in the second recesses;
rotating the plate cylinder while keeping the outer surface of the printing plate in contact with a substrate surface of a printed substrate to transfer the coating liquid held in the second recesses to the substrate surface of the printed substrate, wherein
a ratio of a maximum volume of the coating liquid held by the second recesses per unit area on the outer surface of the printing plate to a maximum volume of the coating liquid held by the first recesses per unit area on the outer surface of the anilox roll is determined to be a ratio ranging from 0.50 to 2.00.

2. The method of producing a printed substrate according to claim 1, wherein a doctor roll configured to rotate while being in contact with an outer surface of the anilox roll is disposed such that the doctor roll draws an excess portion of the coating liquid supplied to the outer surface of the anilox roll.

3. The method of producing a printed substrate according to claim 2, wherein the ratio of the maximum volume of the coating liquid held by the second recesses per unit area on the outer surface of the printing plate to the maximum volume of the coating liquid held by the first recesses per unit area on the outer surface of the anilox roll is determined to be a ratio ranging from 0.90 to 1.50.

4. The method of producing a printed substrate according to claim 2, wherein the ratio of the maximum volume of the coating liquid held by the second recesses per unit area on the outer surface of the printing plate to the maximum volume of the coating liquid held by the first recesses per unit area on an outer surface of the anilox roll is determined to be a ratio ranging from 0.90 to 1.40.

5. The method of producing a printed substrate according to claim 1, further comprising:
scraping an excess portion of the coating liquid supplied to the outer surface of the anilox roll with a doctor blade that is in contact with an outer surface of the anilox roll, wherein
the ratio of the maximum volume of the coating liquid held by the second recesses per unit area on the outer surface of the printing plate to the maximum volume of the coating liquid held by the first recesses per unit area on an outer surface of the anilox roll is determined to be a ratio ranging from 0.50 to 1.70.

6. The method of producing a printed substrate according to claim 5, wherein the ratio of a maximum volume of the coating liquid held by the second recesses per unit area on the outer surface of the printing plate to the maximum volume of the coating liquid held by the first recesses per unit area on the outer surface of the anilox roll is determined to be a ratio ranging from 0.90 to 1.40.

7. The method of producing a printed substrate according to claim 1, wherein in the transferring, the coating liquid held in the second recesses of the printing plate is transferred to a substrate surface of the printed substrate by rotating the plate cylinder while moving a stage that sucks and holds the printed substrate relative to the plate cylinder.

8. The method of producing a printed substrate according to claim 1, wherein in the transferring, the coating liquid held in the second recesses of the printing plate is transferred to the substrate surface of the printed substrate by rotating the plate cylinder while moving the plate cylinder relative to a stage that sucks and holds the printed substrate.

9. The method of producing a printed substrate according to claim 1, wherein
a resin solution containing an oriented film forming resin that orients liquid crystal molecules or an insulative resin is used as the coating liquid, and
a display panel substrate of a display panel is used as the printed substrate coated with the coating liquid.
